(19) United States
(12) Patent Application Publication
(10) Pub. No.: US 2024/0232672 A1
(43) Pub. Date: Jul. 11, 2024

(54) UTILIZING WEAK MEASUREMENTS TO REVEAL INFORMATION CONTENT VIA AN INTERCEPT AND RESEND PROCESS ON A QUANTUM INTERCONNECT LINK

(71) Applicants: Mellanox Technologies, Ltd., Yokneam (IL); Bar-Ilan University, Ramat Gan (IL)

(72) Inventors: Yuval IDAN, Ramat Gan (IL); Avishai ELITZUR, Ramat Gan (IL); Elad MENTOVICH, Tel Aviv (IL); Tali SEPTON, Haifa (IL); Eliahu COHEN, Ramat Gan (IL); Taylor Lee PATTI, Orange, CA (US); Moshe ORON, Rehovot (IL); Yonatan PIASETZKY, Tel Aviv (IL)

(21) Appl. No.: 18/492,315

(22) Filed: Oct. 23, 2023

(30) Foreign Application Priority Data
Jan. 11, 2023 (IL) 299832

(51) Int. Cl. G06N 10/20

(52) U.S. Cl. CPC G06N 10/20

(57) ABSTRACT

Methods, apparatuses, and computer program products for intercepting a transmitted value and resending quantum particles to avoid detection on a quantum interconnect link are provided. An example method includes, intercepting a subset of quantum particles transmitted on the quantum interconnect link. The method further includes determining characteristics of one or more degrees of freedom of the subset of intercepted quantum particles. Additionally, the method includes inferring the value based on the characteristics of the one or more degrees of freedom of the subset of intercepted quantum particles. The method continues by predicting a state of the one or more degrees of freedom of the subset of intercepted quantum particles. Further, the method includes encoding an output subset of quantum particles with characteristics based at least in part on the predicted state and transmitting the output subset of quantum particles on the quantum interconnect link.

### CROSS-REFERENCE TO RELATED APPLICATION

This application claims the benefit of Israeli Patent Application No. 299,832, filed Jan. 11, 2023, the entire contents of which is hereby incorporated by reference in its entirety.

### TECHNOLOGICAL FIELD

Embodiments of the present disclosure relate generally to methods, apparatuses, and computer program products for intercepting communications on a quantum interconnect link and inferring encoded values transmitted on the quantum interconnect link while limiting the likelihood of detection.

### BACKGROUND

Quantum computing applications leverage quantum mechanics to communicate data over a quantum interconnect link. Communications over a quantum interconnect link are uniquely secure because measurements of a quantum interconnect link detectably disturb the link. For example, projective measurement techniques typically collapse the quantum state of a transmitted quantum particle to one of the eigenstates of the measured operator. Even weak measurements typically produce a detectable change to the measured quantum particles, and therefore third parties typically cannot gather information about the quantum communications using even weak measurement techniques without detection. Through applied effort, ingenuity, and innovation, many of these identified problems have been solved by developing solutions that are included in embodiments of the present disclosure, many examples of which are described in detail herein.

### BRIEF SUMMARY

Various embodiments are directed to eavesdropping techniques for minimizing a likelihood of detection by the transmitter and/or receiver of values transmitted across a quantum interconnect link. Specifically, various embodiments provide techniques for inferring an encoded value associated with one or more quantum particles that are intercepted while transmitted across a quantum interconnect link, predicting the state of the one or more quantum particles, and transmitting one or more quantum particles encoded according to the predicted state. With reference to an example method for eavesdropping a value transmitted on a quantum interconnect link, the method may comprise receiving a subset of intercepted quantum particles of a plurality of quantum particles transmitted on the quantum interconnect link, determining one or more characteristics of one or more degrees of freedom of the subset of intercepted quantum particles, inferring the value based at least in part on the one or more characteristics of the one or more degrees of freedom of the subset of intercepted quantum particles, predicting a state of the one or more degrees of freedom of the subset of intercepted quantum particles, encoding an output subset of quantum particles with characteristics based at least in part on the predicted state, and transmitting the output subset of quantum particles on the quantum interconnect link.

In some embodiments, determining one or more characteristics of one or more degrees of freedom of the subset of intercepted quantum particles may comprise performing a weak measurement in a first degree of freedom and utilizing the result of the weak measurement to determine a characteristic of a second degree of freedom, and wherein the first degree of freedom correlates with the second degree of freedom.

In some embodiments, the method may further comprise recording a timestamp associated with state information of the subset of intercepted quantum particles.

In some embodiments, the method may further comprise counting the subset of intercepted quantum particles, recording a statistical distribution of the subset of intercepted quantum particles, and transmitting quantum data reflecting the statistical distribution of the subset of intercepted quantum particles.

In some embodiments, the plurality of quantum particles may be transmitted on the quantum interconnect link between a transmitter and a receiver. In such embodiments, receiving the subset of intercepted quantum particles of the plurality of quantum particles may comprise receiving, via an interceptor the subset of intercepted quantum particles such that a remaining portion of the plurality of quantum particles bypass the interceptor. In addition, transmitting the output subset of quantum particles on the quantum interconnect link may comprise combining the output subset of quantum particles with the remaining portion of the plurality of quantum particles.

In some embodiments, the one or more degrees of freedom may comprise one or more of: polarization, time-of-arrival, spatial displacement, relative phase, orbital angular momentum, spatial modes, energy/frequency, quantized quadratures, and/or spin.

In some embodiments, the inferred value may represent one or more qudits.

In some embodiments, determining one or more characteristics of one or more degrees of freedom of the subset of intercepted quantum particles may comprise identifying one or more measured degrees of freedom, and determining the characteristic of the one or more measured degrees of freedom.

An example apparatus for eavesdropping a value transmitted on a quantum interconnect link is further provided. The example apparatus may comprise a quantum measurement device coupled with the quantum interconnect link. In some embodiments, the quantum measurement device may be configured to receive a subset of intercepted quantum particles of a plurality of quantum particles, wherein the quantum measurement device is configured to determine one or more characteristics of one or more degrees of freedom of the subset of intercepted quantum particles. The apparatus may further comprise digital conversion circuitry electrically connected to the quantum measurement device, wherein the digital conversion circuity is configured to infer the value based at least in part on the one or more characteristics of the one or more degrees of freedom of the subset of intercepted quantum particles. The apparatus may further comprise processing circuitry electrically connected to the digital conversion circuitry, wherein the processing circuitry is configured to predict a state of the one or more degrees of freedom of the subset of intercepted quantum particles. In addition, the apparatus may further comprise an quantum encoding device configured to generate output optical data, wherein the output optical data comprises an output subset of quantum particles encoded with characteristics based at least in part on the predicted state.

In some embodiments, determining one or more characteristics of one or more degrees of freedom of the subset of intercepted quantum particles may comprise performing a weak measurement in a first degree of freedom and utilizing the result of the weak measurement to determine a characteristic of a second degree of freedom, and wherein the first degree of freedom correlates with the second degree of freedom.

In some embodiments, the apparatus may further comprise recording circuitry, wherein the recording circuitry is configured to record the one or more characteristics associated with the one or more degrees of freedom of the subset of intercepted quantum particles.

In some embodiments, the recording circuitry may be further configured to count the intercepted plurality of quantum particles and record a statistical distribution of the subset of intercepted quantum particles, such that the quantum encoding device on the eavesdropper's side generates as an output optical data which reflects the statistical distribution of the subset of intercepted quantum particles.

In some embodiments, the apparatus may further comprise an interceptor and a beam combiner, wherein the interceptor is configured to transmit the subset of intercepted quantum particles to the quantum measurement device such that a remaining portion of the plurality of quantum particles bypass the interceptor; and wherein the beam combiner is configured to combine the output optical data with the remaining portion of the plurality of quantum particles.

In some embodiments, the one or more degrees of freedom of the subset of intercepted quantum particles comprise one or more of: polarization, time-of-arrival, spatial displacement, relative phase, orbital angular momentum, spatial modes, energy/frequency, quantized quadratures, and/or spin.

In some embodiments, the inferred value may represent one or more qudits.

In some embodiments, determining one or more characteristics of one or more degrees of freedom of the subset of intercepted quantum particles may comprises identifying one or more measured degrees of freedom and determining the characteristic of the one or more measured degrees of freedom.

An example computer program product for eavesdropping a value transmitted on a quantum interconnect link is further provided. In some embodiments, the computer program product may comprise at least one non-transitory computer-readable storage medium storing program instructions that, when executed, cause the computer program product to receive a subset of intercepted quantum particles of a plurality of quantum particles transmitted on the quantum interconnect link. In addition, the computer program product may determine one or more characteristics of one or more degrees of freedom of the subset of intercepted quantum particles, infer the value based at least in part on the one or more characteristics of the one or more degrees of freedom of the subset of intercepted quantum particles, predict a state of the one or more degrees of freedom of the subset of intercepted quantum particles, encode an output subset of quantum particles with characteristics based at least in part on the predicted state, and transmit the output subset of quantum particles on the quantum interconnect link.

In some embodiments, the computer program product may further comprise counting the subset of intercepted quantum particles, recording a statistical distribution of the subset of intercepted quantum particles, and causing a quantum encoding device to transmit an output stream of optical data reflecting the statistical distribution of the subset of intercepted quantum particles.

In some embodiments wherein the plurality of quantum particles are transmitted on the quantum interconnect link between a transmitter and a receiver, receiving a subset of intercepted quantum particles of the plurality of quantum particles may comprise receiving, via an interceptor the subset of intercepted quantum particles such that a remaining portion of the plurality of quantum particles bypass the interceptor, and transmitting the output subset of quantum particles on the quantum interconnect link may comprise combining the output subset of quantum particles with the remaining portion of the plurality of quantum particles.

In some embodiments, the one or more degrees of freedom may comprise one or more of: polarization, time-of-arrival, spatial displacement, relative phase, orbital angular momentum, spatial modes, energy/frequency, quantized quadratures, and/or spin.

### BRIEF DESCRIPTION OF THE DRAWINGS

Having thus described certain example embodiments in general terms, reference will now be made to the accompanying drawings. The components illustrated in the figures may or may not be present in certain embodiments described herein. Some embodiments may include fewer (or more) components than those shown in the figures.

FIG. 1 illustrates an example quantum interconnect communication system including an eavesdropper in accordance with one or more embodiments.

FIG. 2 illustrates a block diagram of an example quantum interconnect eavesdropper in accordance with an example embodiment.

FIG. 3 illustrates an example quantum measurement processing device on a quantum interconnect eavesdropper in accordance with an example embodiment.

FIG. 4 illustrates a block diagram of an example quantum measurement processing device on a quantum interconnect receiver/transmitter in accordance with an example embodiment.

FIG. 5 illustrates a flowchart of an example method for intercepting and resending a quantum communication in accordance with an example embodiment.

FIG. 6 illustrates a flowchart of an example method for transmitting quantum particles according to statistical data measured and recorded in accordance with an example embodiment.

FIG. 7 illustrates a flowchart of an example method for adjusting the quantum interconnect eavesdropper based on received bases in accordance with an example embodiment.

### DETAILED DESCRIPTION

### Overview

Various embodiments will now be described more fully hereinafter with reference to the accompanying drawings in which some but not all embodiments are shown. Indeed, embodiments may take many different forms and should not be construed as limited to the explicit disclosure set forth herein; rather these embodiments are provided so that this disclosure will satisfy applicable legal requirements. Like reference numerals refer to like elements throughout.

Example embodiments are directed to methods, apparatuses, and computer program products for intercepting, measuring, and resending quantum particles transmitted on a quantum interconnect link in a manner that minimizes a likelihood of detection.

Quantum communication links generally provide a secure pathway to communicate data by relying on certain known and predictable characteristics of quantum mechanics. Quantum communication devices transmit and receive information using quantum bits (qubits) or qudits by encoding values in the physical characteristics of quantum particles. A quantum particle comprises a plurality of degrees of freedom which are distinct physical parameters that make up the state of the particle, for example, the spin, polarization, spatial position, phase, time of arrival, angular momentum, and/or orbital momentum may all be degrees of freedom of a quantum particle. In addition, each degree of freedom has one or more bases (plural form of “basis”) which are mutually orthogonal vectors defined within the specific degree of freedom. For example, one set of basis vectors used to define the polarization degree of freedom is the “rectilinear basis” in which a quantum particle polarized at zero degrees (e.g., horizontal) represents a first value (e.g., 1) while a quantum particle polarized at ninety degrees (e.g., vertical) represents a second distinct value (e.g., 0). As described herein, a characteristic represents the measured physical value of the quantum particle within the selected degree of freedom. The state of the quantum particle refers generally to the physical characteristics of the quantum particle, across any number of degrees of freedom.

In order to transmit information in a quantum communication network, a transmitter selects a degree of freedom and a basis. For example, a transmitter may select the polarization degree of freedom and the rectilinear basis. A transmitter may then modify the physical characteristic within the degree of freedom to encode a value. For example, a transmitter may polarize a quantum particle at an angle of ninety degrees (e.g., vertical polarization) to encode a ‘1’ and polarize a quantum particle and an angle of zero degrees (e.g., horizontal polarization) to encode a ‘0.’ Further, the physical condition of a quantum particle may relate generally to all physical characteristics across one or more degrees of freedom of a quantum particle.

In addition, degrees of freedom may be interconnected such that characteristics of one degree of freedom may be reflected in a second degree of freedom. For example, a quantum device may infer characteristics related to the spin of a quantum particle based on measurements of the spatial position using a quantum measurement device such as a Stern-Gerlach device. Further, in another example, a quantum device may infer characteristics related to the polarization of a quantum particle again based on the spatial position using a bi-refrigerant crystal. Thus, measurements may be performed in a first degree of freedom to infer information about a second degree of freedom. Similarly, imparting a physical characteristic in one degree of freedom may indirectly impart a related characteristic on another degree of freedom.

However, the physical characteristics of quantum particles are sensitive and can be easily influenced by any external interference. External interference can occur by way of extraneous electromagnetic fields, changes in temperature in the system, cross talk between nearby optical or electrical lines, or other similar disturbances. In addition, performing measurements on the quantum interconnect line may disturb the physical characteristics of transmitted quantum particles. Thus, external influences and/or processes for preparing and/or measuring the state of the quantum particles may imply a detectable adjustment to the wanted and/or ideal state of the quantum particle. For example, standard measuring techniques, such as projective measurement, can cause the quantum particle characteristic to collapse to one of the eigenstates of the measured operator. Traditionally, by comparing a subset of the transmitted values with corresponding received values, a transmitter and receiver in a quantum communication network can reliably detect an eavesdropper using projective measurements if the latter introduces a sufficient amount of disturbance.

Since quantum communications have presented a reliable way to detect the presence of an eavesdropper, quantum interconnect links have been utilized to facilitate the transmission and reception of secure keys while ensuring that no eavesdroppers are present. This process is known as quantum key distribution. Using quantum communication techniques, a sender and receiver could theoretically guarantee the security of a transmitted key and reliably use the key in secure operations. Transmissions utilizing a quantum communication link can make it difficult for a third party to intercept the quantum communication without detection.

Various methods, apparatuses, and computer program products are provided to counteract these advances in secure quantum communication by providing techniques allowing a third party eavesdropper to infer certain information related to the state and encoded value of transmitted quantum particles, while limiting the likelihood of detection. Through appropriate configurations for decoding the inferred information, the eavesdropper may obtain information transmitted across the quantum interconnection link without detection.

For example, using variable-strength quantum measurements or weak measurements, an eavesdropper may be able to gather partial information about the encoded value of transmitted quantum particles while only minimally (e.g., undetectably) changing the state of the quantum particles transmitted across the quantum interconnect link in cases of loss, noise and setup imperfections. In contrast, an eavesdropper using projective (or strong) measurements may collapse the state of a quantum particle and may change the encoded value of a detectable number of transmitted quantum particles. The sender and/or receiver may be able to determine based on the number of changes to the encoded values if an eavesdropper utilizing projective measurements was gathering information about the communication. Thus, an initial step to determine the encoded valued of a transmitted quantum particle while lowering the chance of being detected is to use variable-strength, or weak measurements to predict the state information of the transmitted quantum particle using an auxiliary degree of freedom or an additional probe particle.

Variable-strength, or weak measurements allow an eavesdropper to gather information about the physical characteristics of one or more transmitted quantum particles while only minimally changing the state of the one or more transmitted quantum particles and/or the quantum interconnect link. The eavesdropper may perform a weak measurement, utilizing a degree of freedom that is not used by the transmitter and the receiver to encode/decode a value (e.g., an auxiliary degree of freedom), thus, the transmitter and receiver may never measure and/or analyze the affected auxiliary degree of freedom. Moreover, weak measurements are variable-strength, meaning the eavesdropper may adjust the measurements to maximize measured information while minimizing the impact the measurements have on the system. This procedure can be performed in accordance with a natural or artificial source of noise to help the eavesdropper avoid detection. It can be also accompanied by a photon-number splitting attack or with optimal quantum cloning. As an example, an eavesdropper may use a quantum measurement device, such as a Stern-Gerlach or similar device utilizing weak interactions to perform a weak measurement. When passed through the device, quantum particles will displace differently based on the spin of the particle. An eavesdropper may measure the spatial displacement of the quantum particles and infer the spin of the quantum particle based on the spatial displacement. This technique causes a minor variation in the spatial displacement of the quantum particles but has negligible effect on the spin of the quantum particles. Thus, a quantum interconnect receiver decoding values based on the spin of the quantum particles will be unable to detect the presence of the eavesdropper. In addition, an eavesdropper may vary the length and/or strength of the Stern-Gerlach or similar device to perform a weak measurement while minimizing the impact on the spatial displacement of the measured quantum particles.

In addition to using weak measurement techniques to determine the characteristics of the state of the quantum particle (or other quantum particle), an eavesdropper attempting to avoid detection may take other steps to remain undetected. For example, an eavesdropper may predict the state of the quantum particle (e.g., the state of the quantum particle when it is received at the receiver) based on the information determined from the weak measurements and possibly with the use of prior knowledge as well. Predicting the state allows the eavesdropper to manipulate various characteristics of regenerated quantum particles (e.g., characteristics within one or more degrees of freedom) representing the predicted state of the intercepted quantum particles. An eavesdropper may then transmit the regenerated quantum particles to the intended quantum interconnect receiver along the quantum interconnect link, thereby veiling the presence of any measurements made to the intercepted quantum particles.

Further, an eavesdropper may record statistics related to quantum particle composition, the time, the frequency, the displacement, the path, the number of quantum particles transmitted on the quantum interconnect link, and/or any other quantum characteristic of the particle or link. In some instances, a quantum interconnect transmitter and quantum interconnect receiver may attempt to thwart a third party eavesdropper's attempts to intercept information by varying the profile of the transmitted stream of quantum particles. This variation may include variations in the number of quantum particles sent and the frequency with which they are sent. A quantum interconnect receiver may monitor the profile of the transmitted data and identify a potential eavesdropper if the received profile does not match the profile transmitted by the quantum interconnect transmitter. Thus, in order to avoid detection, an eavesdropper may determine and record various aspects of a statistical distribution (e.g., reflecting bunching, anti-bunching, quantum particle number, fock state, time received, frequency, and/or one or more other statistics) of the incoming quantum particle stream, and re-transmit an output quantum particle stream according to the recorded observations.

As an additional step, eavesdroppers may access the encoded bases for the transmission between the quantum interconnect transmitter and the quantum interconnect receiver and adjust measurement and transmission parameters based on the received bases. In general, once a quantum key has been transmitted as part of a quantum key distribution scheme, the quantum interconnect transmitter and the quantum interconnect receiver will exchange the bases which were used in encoding the value of the transmitted qubits and subsequently decoding the received qubits. Exchanging bases allows the quantum interconnect transmitter and the quantum interconnect receiver to determine the transmitted values which will be used in the quantum key and to detect an eavesdropper, particularly an eavesdropper utilizing projective measurements. However, in instances in which the eavesdropper also intercepts or otherwise accesses the transmitted bases, the eavesdropper may determine necessary adjustments to the determination sequence so as to enable collection of values from the quantum interconnect link with only a minor disturbance which is hard to detect. For example, an eavesdropper may determine that the eavesdropper's measuring hardware may need to be adjusted to reduce disturbance to the transmitted quantum particles as part of an adaptive protocol.

These techniques enable an eavesdropper on a quantum interconnect link to determine encoded values of transmitted quantum particles usually without being detected by a quantum interconnect transmitter or receiver.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present invention. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Architecture for Intercepting and Resending Quantum Particles in a Quantum Communication System

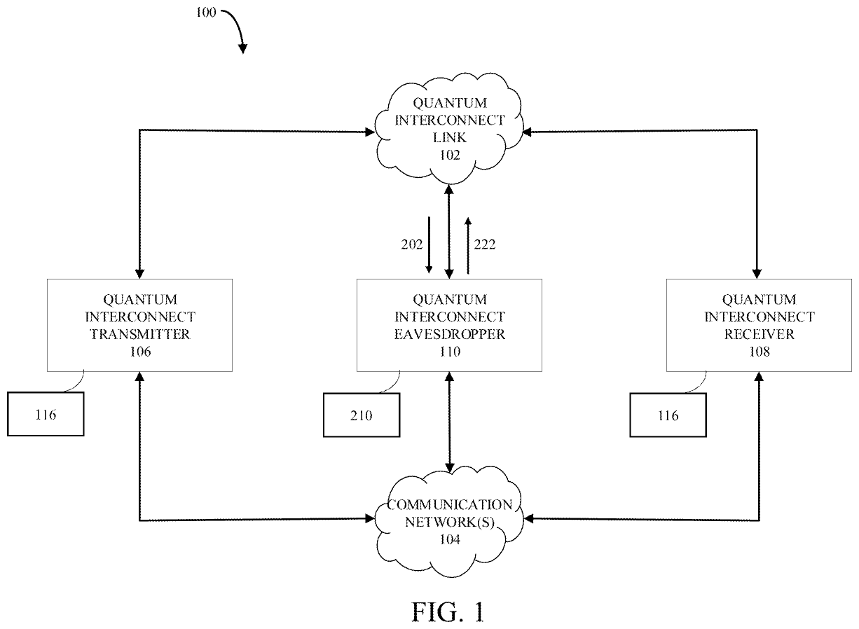

FIG. 1 illustrates an example quantum communication network 100 according to an embodiment of the present invention. As shown in FIG. 1, a quantum communication network 100 may include a quantum interconnect link 102 facilitating quantum communication between a quantum interconnect transmitter 106 and a quantum interconnect receiver 108. In addition, the quantum interconnect transmitter 106 and quantum interconnect receiver 108 may be communicatively connected to a communication network 104 providing electronic and/or optical communication between the quantum interconnect transmitter 106 and the quantum interconnect receiver 108. Further, FIG. 1 depicts a quantum interconnect eavesdropper 110 communicatively connected to the quantum interconnect link 102, over which the quantum interconnect transmitter 106 and the quantum interconnect receiver 108 transmit and receive quantum communications, and the communication network 104 over which the quantum interconnect transmitter 106 and the quantum interconnect receiver 108 transmit and receive communications over a standard, non-classical communication line.

The illustration of FIG. 1 includes a depiction of a quantum interconnect link 102. A quantum interconnect link 102 may be any physical cable, conduit, wire, channel, line or the like that is capable of transmitting quantum data encoded via a stream of transmitted quantum particles. As non-limiting examples, a quantum interconnect link 102 may comprise an optical line or a quantum line. The quantum interconnect link 102 is configured to allow quantum particles to pass along the quantum interconnect link 102 between a quantum interconnect transmitter 106 and a quantum interconnect receiver 108. Travel of each of the quantum particles along the quantum interconnect link 102 may be characterized according to a plurality of degrees of freedom of the quantum particle. For example, the polarization, time-of-arrival, spatial displacement, relative phase, orbital angular momentum, spatial modes, energy/frequency, quantized quadratures, and/or spin of the quantum particle, as examples, may be manipulated by the quantum interconnect transmitter 106. By selectively manipulating various degrees-of-freedom of the particle, the characteristics of the particle with respect to each of the various degrees-of-freedom may be selectively set to encode data values to the quantum particle. Data may be transmitted across the quantum interconnect link by selectively imparting certain characteristics to a plurality of quantum particles transmitted across the quantum interconnect link 102. Collectively, the characteristics of each of the plurality of quantum particles define the data transmitted across the quantum interconnect link 102.

In some embodiments, a quantum interconnect link 102 may be utilized to transmit and receive quantum data by encoding the data in a particular degree of freedom (e.g., polarization, time-of-arrival, spatial displacement, relative phase, orbital angular momentum, spatial modes, energy/frequency, quantized quadratures, spin, or other similar physical property). In a selected degree of freedom, a basis is chosen representing the potential states of the transmitted quantum data. For example, a quantum communication network 100 that has selected the spin of the quantum particle as the degree of freedom in which to encode data, may select spin up and spin down as the two orthogonal states representing two different encoded values. Quantum particles that can represent one of two orthogonal states (or both states simultaneously), referred to as “qubits,” are the basic unit of quantum information in a quantum communication network 100. However, in some embodiments, a quantum interconnect link 102 may be utilized to transmit and receive quantum data in a multi-state combination (qudits), for example, by varying a combination of physical characteristics across multiple degrees of freedom. In addition, quantum particles transmitted on a quantum interconnect link 102 may rely on quantum properties such as quantum superposition and/or quantum entanglement to facilitate the transmission of information. These quantum properties allow for the transmission and/or verification of additional data for a given quantum transmission.

In some embodiments, the quantum interconnect link 102 may be utilized to facilitate a quantum key distribution (QKD) process in which a secret key is created between two devices (e.g., a quantum interconnect transmitter 106 and a quantum interconnect receiver 108) connected to a quantum interconnect link 102. In these and other embodiments, a third party (e.g., a quantum interconnect eavesdropper 110) may desire to intercept quantum communications transmitted on the quantum interconnect link 102 without detection.

FIG. 1 further depicts a quantum interconnect transmitter 106. A quantum interconnect transmitter 106 may be any device capable of interfacing with a quantum interconnect link 102 and a communication network 104 and capable of generating and transmitting quantum particles (e.g., quantum particles). While primarily described as a quantum interconnect transmitter 106 and a quantum interconnect receiver 108, in some embodiments, each may be a transceiver capable of both transmitting and receiving quantum particles and may be referred to herein as a quantum device. In some embodiments, a quantum interconnect transmitter 106 may encode data on a quantum particle by varying a physical characteristic of the transmitted quantum particle with respect to a specific quantum basis. A quantum basis may refer to a set of mutually orthogonal vectors defined within the specific degree of freedom. For example, in an embodiment in which the spin of the quantum particle is the degree of freedom selected for encoding values, a quantum interconnect transmitter 106 may spin a quantum particle up to encode a ‘1’ and spin a quantum particle down to encode a ‘0.’

In some embodiments, a quantum interconnect transmitter 106 may establish a plurality of bases within a degree of freedom, any one of which a value may be encoded in. For example, in an instance in which polarity is selected as the degree of freedom in which to encode a value, a quantum interconnect transmitter 106 may choose to vary the polarization such that data is encoded according to a rectilinear, diagonal, or circular polarization basis. The “rectilinear basis” may refer to the pair of rectilinear polarizations comprising a horizontal polarization of zero degrees and a vertical polarization of ninety degrees. The “diagonal basis” may refer to the pair of diagonal polarizations comprising the diagonal polarization of 45 degrees and the diagonal polarization of 135 degrees. The “circular basis” may refer to the pair of circular polarizations comprising the left circular polarization and the right circular polarization. Similarly, orthogonal quantum bases may be defined for all degrees of freedom for which a quantum interconnect transmitter 106 may vary the physical characteristics of the quantum particle. In some embodiments, a quantum interconnect transmitter 106 may additionally have the capability to utilize quantum principles such as quantum superposition and/or quantum entanglement to facilitate the transmission of quantum data.

As depicted in FIG. 1, in some embodiments, a quantum interconnect transmitter 106 may further include a quantum measurement processing device 116. The quantum measurement processing device 116 may be any processing device comprising hardware, software, and/or firmware configured to determine the required physical characteristics of a quantum particle to encode a specified value. A quantum measurement processing device 116 may further configure a modulating device to produce output quantum particles according to the determined physical characteristics. In some embodiments, encoding a specified value may include determining the degree of freedom and basis on which data will be encoded and further determining the physical characteristics at which the quantum particles will be generated to represent the encoded values. In addition, the quantum measurement processing device 116 may receive information representing one or more characteristics of a received quantum particle from one or more components of an optical receiver. A quantum measurement processing device 116 may infer an encoded value based at least in part on the received characteristics.

In some embodiments, the quantum measurement processing device 116 may further facilitate communication on a communication network 104 using standard data protocols. A quantum measurement processing device 116 may utilize a communication network 104 to exchange bases used to transmit and receive the data once transmission has occurred.

FIG. 1 further depicts a quantum interconnect receiver 108. Similar to a quantum interconnect transmitter 106, a quantum interconnect receiver 108 may be any device capable of interfacing with a quantum interconnect link 102 and a communication network 104 and capable of receiving quantum particles. In addition, a quantum interconnect receiver 108 may also be configured to generate and/or transmit quantum particles as discussed in relation to the quantum interconnect transmitter 106. Further, in some embodiments, a quantum interconnect receiver 108 may be configured to reflect and/or re-transmit transmitted quantum particles through the quantum interconnect link 102 and back to the quantum interconnect transmitter 106 or another device connected to the quantum interconnect link 102. In some embodiments, a quantum interconnect transmitter 106 may be configured to determine the quantum state of a received quantum particle with respect to a specific quantum basis, which may include, for example, determining the spin of the quantum particle, the polarization of the quantum particle, the timing and/or spatial position of the quantum particle, the phase of the quantum particle, and/or other similar measurements. In some embodiments, the quantum interconnect receiver 108 may randomly select a quantum basis from a set of possible quantum bases to measure the particular quantum state of a received quantum particle. In quantum key distribution (QKD) environments, a quantum interconnect receiver 108 may later compare quantum bases randomly selected by the quantum interconnect receiver 108 with transmitted quantum bases and utilize the information from the transmissions in which the selected quantum basis match the transmitted quantum basis to determine a secure key. Further, the exchange of bases may further facilitate determining if a quantum interconnect eavesdropper 110 has intercepted the transmission.

As described in relation to the quantum interconnect transmitter 106, while the quantum interconnect receiver 108 is primarily described as a receiver, in some embodiments, the quantum interconnect receiver 108 may be a transceiver capable of both transmitting and receiving quantum particles and may be referred to herein as a quantum interconnect device.

As depicted in FIG. 1, in some embodiments, a quantum interconnect receiver 108 may further include a quantum measurement processing device 116. A quantum measurement processing device 116 may enable a quantum interconnect receiver 108 to determine the physical characteristics of a quantum particle required to decode a specified value based on information received from a quantum particle capture device or optical receiver. In some embodiments, a quantum measurement processing device 116 may also be utilized to determine and/or store bases used in the determination of a quantum particle's value.

FIG. 1 further depicts a quantum interconnect eavesdropper 110. A quantum interconnect eavesdropper 110 may be any device capable of intercepting quantum particle transmissions between a quantum interconnect transmitter 106 and a quantum interconnect receiver 108 along a quantum interconnect link 102. A quantum interconnect eavesdropper 110 may physically interface with the quantum interconnect link 102 to intercept (receive), measure, and resend (transmit) transmitted quantum particles. One method of measuring quantum particles transmitted on a quantum interconnect link 102 is to use projective, or strong, measurements. Projective measurements can be easily detected in the transmission of quantum particles because projective measurements often alter the physical characteristics of the measured quantum particles. Uncertainty is inherent in the measurement of quantum particles and thus, most measurements represent a probability that a quantum particle has a certain position, momentum, or other physical characteristic. However, determining the precise physical property of a quantum particle causes the transmitted quantum particle to collapse to one of the eigenstates of the measured operator. An eigenstate is a state in which the quantum particle possesses a quantifiable physical characteristic, with no uncertainty. From then on, the quantum particle will exhibit the same physical characteristic with respect to the measured operator. Unfortunately, the quantum particle may collapse into an eigenstate that represents a different value when considered in relation to the basis for the selected degree of freedom. When this occurs, the transmitted quantum particle, when measured, will result in a different value than the value originally sent. For example, a quantum particle may be transmitted encoding a value in a degree of freedom based on the spin of the quantum particle, for example, with a spin up characteristic, representing a ‘1.’ A quantum interconnect eavesdropper 110 performing projective measurements may collapse the quantum particle into an unpredicted base state, for example, with a spin down characteristic, representing a ‘0.’ Such a disturbance will likely be detected when the quantum interconnect transmitter 106 and the quantum interconnect receiver 108 exchange bases after transmission.

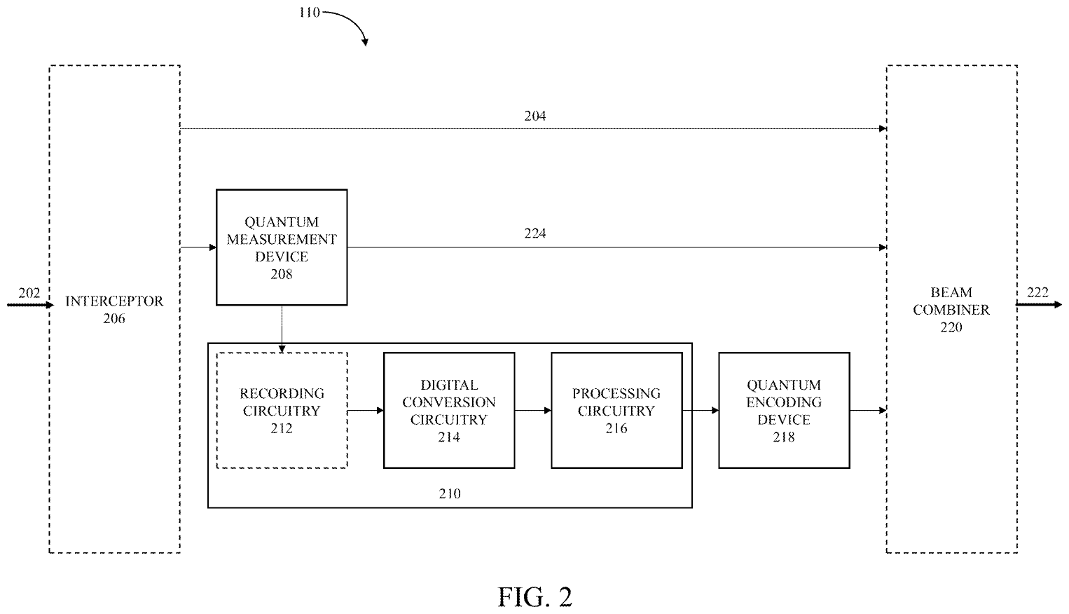

As described in conjunction with FIG. 2, a second method of measuring quantum particles is to use variable-strength quantum measurements, or weak measurements. Weak measurements allow a quantum interconnect eavesdropper 110 to apply a sequence of measurements that provide the eavesdropper with minimal information but rarely collapse the quantum state, making it more difficult for a quantum interconnect transmitter 106 and/or a quantum interconnect receiver 108 to detect the eavesdropper. In addition, weak measurements are generally performed on a degree of freedom that is not utilized by the transmitter and the receiver to encode a value (e.g., an auxiliary degree of freedom).

As one example, in an instance in which the quantum particle polarization is the degree of freedom utilized to convey data, a quantum interconnect eavesdropper 110 may determine the polarization of a quantum particle by passing the quantum data stream through a bi-refrigerant crystal. In some embodiments, a bi-refrigerant crystal may cause a spatial displacement in the quantum data stream based on the polarization of the quantum data. Thus, a quantum interconnect eavesdropper 110 may determine information related to the polarization of the quantum data without measuring the polarization directly, which may collapse the quantum data into one of the basis eigenstates. Information recovered from the spatial displacement may aid the quantum interconnect eavesdropper 110 in determining the encoded value of the quantum data, while leaving the polarization degree of freedom virtually undisturbed.

FIG. 1 further depicts a communication network 104. A communication network 104 may be any network or system of networks allowing wired and/or wireless communication between connected nodes, for example, a wired or wireless local area network (LAN), personal area network (PAN), metropolitan area network (MAN), wide area network (WAN), or the like. A communication network 104 may also include any hardware, software and/or firmware required for implementing the one or more networks (e.g., network routers, switches, hubs, etc.). For example, communication network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communication network 104 may include a public network, such as the Internet, a private network, such as an intranet, or combinations thereof, and may utilize a variety of networking protocols now available or later developed including, but not limited to TCP/IP based networking protocols. A communication network 104 may enable a quantum interconnect device to communicate information using the above mentioned protocols.

With reference to FIG. 2, a block diagram of an example quantum interconnect eavesdropper 110 is provided. As shown in FIG. 2, the example quantum interconnect eavesdropper 110 includes an interceptor 206 receiving quantum transmission data 202 from a quantum interconnect link 102. A subset of the quantum transmission data 202 (e.g., quantum bypass data 204) bypasses the measuring circuitry of the quantum interconnect eavesdropper 110 and is transmitted directly to a beam combiner 220. The remaining quantum transmission data 202 is routed to a quantum measurement device 208. The quantum measurement device 208 is further in electric communication with a quantum measurement processing device 210 containing recording circuitry 212, digital conversion circuitry 214, and processing circuitry 216. The quantum measurement processing device 210 is further electrically connected to a quantum encoding device 218. The quantum encoding device 218 generates quantum data that is combined with the quantum non-demolished data 224 and the quantum bypass data 204 by the beam combiner 220 and output on the quantum interconnect link 102 as quantum output data 222.

As depicted in FIG. 2, the example quantum interconnect eavesdropper 110 receives quantum transmission data 202 on a quantum interconnect link (e.g., quantum interconnect link 102). Quantum transmission data 202 may be any quantum data generated to encode one or more values using the physical properties of the quantum particles and transmitted on a quantum interconnect link 102. Quantum particles may include photons, atoms, electrons, and/or other similar particles. In some embodiments, data may be encoded on a quantum particle by manipulating the physical characteristics of a particle in one or more degrees of freedom. The characteristics which may be adjusted are dependent on the degree of freedom on which the transmitted value is to be encoded. In some embodiments, a basis is selected encoding different values based on orthogonal physical characteristics. For example, a quantum interconnect transmitter 106 that has determined to encode data based on polarization as the degree of freedom, may select the “rectilinear basis” comprising the horizontal polarization of zero degrees and the vertical polarization of ninety degrees as the possible encoded states. Quantum particles received in the quantum transmission data 202 having a horizontal polarization may encode one value (e.g., ‘0’) while quantum particles having a vertical polarization may encode a second value (e.g., ‘1’). Similarly, quantum transmission data 202 may utilize a “diagonal basis,” wherein a diagonal polarization of 45 degrees and a diagonal polarization of 135 degrees encode separate values, or a “circular basis,” wherein a left circular polarization and a right circular polarization encode separate values. Similarly, one or more orthogonal quantum bases may be defined for all quantum states for which quantum transmission data 202 may be transmitted. In some embodiments, quantum transmission data 202 may additionally utilize quantum principles such as quantum superposition to transmit a quantum particle exhibiting multiple physical characteristics of a single degree of freedom and/or quantum entanglement allowing a transmitter to retain properties of a transmitted quantum particle for later comparison. Each of these quantum principles can further facilitate the transmission of quantum data.

As further depicted in FIG. 2, in some embodiments, a quantum interconnect eavesdropper 110 may further include an interceptor 206. An interceptor 206 may be any device capable of receiving quantum data and splitting the quantum particles such that a subset of the quantum transmission data 202 is transmitted to a quantum measurement device 208 and a subset of the quantum particles (e.g., quantum bypass data 204) bypass the quantum interconnect eavesdropper 110 hardware and circuitry, and are transmitted directly to the beam combiner 220. In some embodiments, the interceptor 206 may be embodied in an optical beam splitter.

As further depicted in FIG. 2, the example quantum interconnect eavesdropper 110 includes a quantum measurement device 208. A quantum measurement device 208 is any device capable of receiving quantum data and performing measurements to determine one or more characteristics associated with one or more selected degrees of freedom. In order to avoid detection, a quantum measurement device 208 may perform variable-strength quantum measurements, or weak measurements. A weak measurement, or weak interaction projective measurement, allows a quantum measurement device 208 to glean information from the transmitted quantum particles without collapsing the state of the quantum particle to one of the basis states. Further, in some embodiments, the quantum measurement device 208 may perform non-demolishing measurements on a subset of the quantum particles. Non-demolishing measurements may be any measurements that allow the quantum particles to pass through without being absorbed or otherwise demolished. Such quantum particles may be transmitted to the interceptor 206 without modification or re-generation, depicted in FIG. 2 as quantum non-demolished data 224.

As one example in which a quantum particle's polarization is utilized to convey an encoded value, a quantum interconnect eavesdropper 110 may determine the polarization of a quantum particle by passing the quantum particle stream through a bi-refrigerant crystal. In some embodiments, a bi-refrigerant crystal may cause a spatial displacement in the quantum data stream based on the polarization of the quantum data. Thus, a quantum interconnect eavesdropper 110 may determine information related to the polarization of the quantum data without measuring the polarization directly, which may collapse the quantum data into one of the basis eigenstates. Information recovered from the spatial displacement may aid the quantum interconnect eavesdropper 110 in determining the encoded value of the quantum data, as well as in predicting the state of the quantum particle. In addition, glass plates may be utilized to take advantage of Brewster's angle and determine information related to the polarization of the quantum data, once again based on the spatial displacement of the quantum particles.

Similarly, in an instance in which the quantum interconnect transmitter 106 encodes a value utilizing the spin of a quantum particle, a quantum measurement device 208 may utilize one or more Stern-Gerlach devices to determine one or more characteristics related to the spin of the electron based on spatial displacement. For example, a Stern-Gerlach device may cause quantum particles to experience different spatial displacement based on the spin of the particle. A quantum interconnect eavesdropper 110 may use the spatial displacement to determine a spin characteristic of the electron and consequently, the value encoded using the electron spin. Information recovered from the spatial displacement may also aid the quantum interconnect eavesdropper 110 in determining the state of the quantum particle.

In some embodiments, the quantum measurement device 208 may utilize a plurality of components to perform measurements across a plurality of degrees of freedom and/or a plurality of bases.

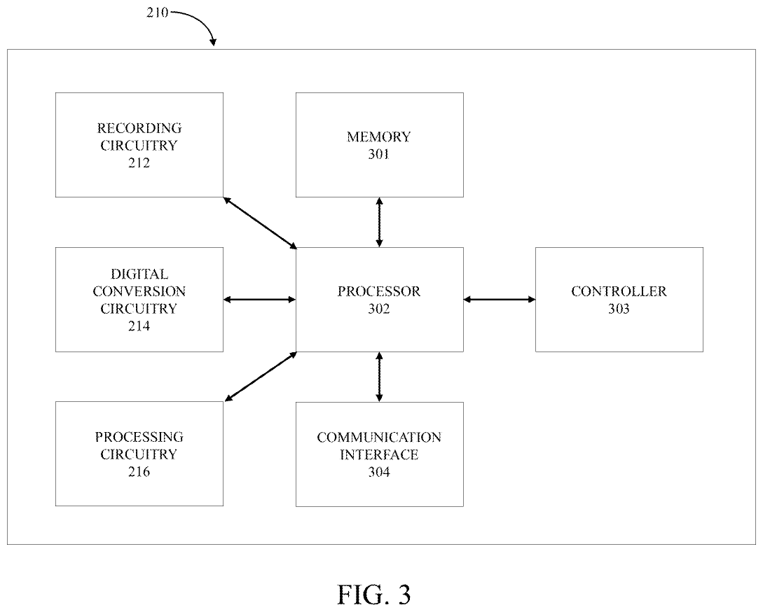

As further depicted in FIG. 2, the example quantum interconnect eavesdropper 110 further includes a quantum measurement processing device 210. The quantum measurement processing device 210 may be any device comprising hardware, software, and/or firmware configured to receive information representing one or more characteristics of quantum data from one or more components of the quantum measurement device 208, infer an encoded value based at least in part on the received characteristics, and predict a state of the quantum particle based on the one or more characteristics. As further described in FIG. 3, a quantum measurement processing device 210 may utilize recording circuitry 212, digital conversion circuitry 214, and/or processing circuitry 216 to perform the operations necessary to infer an encoded value and predict a state of the quantum particle. The quantum measurement processing device 210 may be electrically and/or communicatively connected to both the quantum measurement device 208 and the quantum encoding device 218.

As shown in FIG. 2, the example quantum interconnect eavesdropper 110 further includes a quantum encoding device 218. A quantum encoding device 218 may be any device capable of generating and/or manipulating the physical characteristics of a quantum particle based on the characteristics of the predicted quantum state as determined by the quantum measurement processing device 210. In some embodiments, a quantum encoding device 218 may be configured to manipulate degrees of freedom to correspond to the predicted state. Depending on the measurements performed by the quantum measurement device 208, a quantum encoding device 218 may be required to manipulate the physical characteristics within one or more degrees of freedom (e.g., spin of an electron, polarization of the quantum particle, phase, position, time of arrival, angular momentum, orbital momentum, etc.). In addition, the quantum encoding device 218 may in some embodiments, receive information regarding the statistical distribution of the quantum data as determined by the quantum measurement processing device 210. A quantum encoding device 218, may in some embodiments generate a quantum data stream based on the statistical distribution of the quantum data received by the quantum measurement device 208 and/or the quantum bypass data 204.

As further depicted in FIG. 2, in some embodiments, the quantum encoding device 218 may be electrically and/or optically connected to the beam combiner 220. The beam combiner 220 may be any device capable of receiving multiple streams of quantum data and providing a single stream of quantum output data 222. In some embodiments, the beam combiner 220 may be configured to coordinate the quantum bypass data 204 with the quantum data generated by the quantum encoding device 218. The generated quantum output data 222 incorporates the predicted state of the quantum data based on the measurements performed by the quantum measurement device 208, as well as the synchronized quantum bypass data 204 to closely resemble the received quantum transmission data 202. Thus, detection of eavesdropping activity may be difficult to determine from the perspective of a quantum interconnect transmitter 106 and a quantum interconnect receiver 108.

FIG. 3 illustrates a quantum measurement processing device 210 in accordance with at least some example embodiments of the present disclosure. The quantum measurement processing device 210 includes processor 302, input/output circuitry 303, memory 301, communication interface 304, recording circuitry 212, digital conversion circuitry 214, and processing circuitry 216. In some embodiments, the quantum measurement processing device 210 is configured, using one or more of the sets of circuitry 301, 302, 303, 304, 212, 214, and/or 216, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the quantum measurement processing device 210 provide or supplement the functionality of other particular sets of circuitry. For example, the processor 302 in some embodiments provides processing functionality to any of the sets of circuitry, the memory 301 provides storage functionality to any of the sets of circuitry, the communication interface 304 provides network interface functionality to any of the sets of circuitry, and/or the like.

In some embodiments, the processor 302 (and/or co-processor or any other processing circuitry assisting or otherwise associated with the processor) is/are in communication with the memory 301 via a bus for passing information among components of the quantum measurement processing device 210. In some embodiments, for example, the memory 301 is non-transitory and may include, for example, one or more volatile and/or non-volatile memories. In other words, for example, the memory 301 in some embodiments includes or embodies an electronic storage device (e.g., a computer readable storage medium). In some embodiments, the memory 301 is configured to store information, data, content, applications, instructions, or the like, for enabling the quantum measurement processing device 210 to carry out various functions in accordance with example embodiments of the present disclosure.

The processor 302 may be embodied in a number of different ways. For example, in some example embodiments, the processor 302 includes one or more processing devices configured to perform independently. In some embodiments, the processor 302 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the quantum measurement processing device 210, and/or one or more remote or “cloud” processor(s) external to the quantum measurement processing device 210.

In an example embodiment, the processor 302 is configured to execute instructions stored in the memory 301 or otherwise accessible to the processor. Alternatively or additionally, the processor 302 in some embodiments is configured to execute hard-coded functionality. As such, whether configured by hardware or software methods, or by a combination thereof, the processor 302 represents an entity (e.g., physically embodied in circuitry) capable of performing operations according to an embodiment of the present disclosure while configured accordingly. Alternatively or additionally, as another example in some example embodiments, when the processor 302 is embodied as an executor of software instructions, the instructions specifically configure the processor 302 to perform the algorithms embodied in the specific operations described herein when such instructions are executed.

As one particular example embodiment, the processor 302 is configured to perform various operations associated with eavesdropping a value transmitted on a quantum interconnect link 102. In some embodiments, the processor 302 includes hardware, software, firmware, and/or a combination thereof, that receives a quantum particle of a plurality of quantum particles transmitted on the quantum interconnect link 102. In some embodiments, the processor 302 includes hardware, software, firmware, and/or a combination thereof, that determines one or more characteristics of one or more degrees of freedom of the quantum particle. In some embodiments, the processor 302 includes hardware, software, firmware, and/or a combination thereof, that infers the value based at least in part on the one or more characteristics of the one or more degrees of freedom of the quantum particle. In some embodiments, the processor 302 includes hardware, software, firmware, and/or a combination thereof, that predicts a state of the one or more degrees of freedom of the quantum particle. In some embodiments, the processor 302 includes hardware, software, firmware, and/or a combination thereof, that encodes an output quantum particle with characteristics based at least in part on the predicted state. In some embodiments, the processor 302 includes hardware, software, firmware, and/or a combination thereof, that transmits the output quantum particle on the quantum interconnect link 102.

In some embodiments, the quantum measurement processing device 210 includes input/output circuitry 303 that provides output to the user and, in some embodiments, to receive an indication of a user input. In some embodiments, the input/output circuitry 303 is in communication with the processor 302 to provide such functionality. The input/output circuitry 303 may comprise one or more user interface(s) (e.g., user interface) and in some embodiments includes a display that comprises the interface(s) rendered as a web user interface, an application user interface, a user device, a backend system, or the like. The processor 302 and/or input/output circuitry 303 comprising the processor may be configured to control one or more functions of one or more user interface elements through computer program instructions (e.g., software and/or firmware) stored on a memory accessible to the processor (e.g., memory 301, and/or the like). In some embodiments, the input/output circuitry 303 includes or utilizes a user-facing application to provide input/output functionality to a client device and/or other display associated with a user.

In some embodiments, the quantum measurement processing device 210 includes communication interface 304. The communication interface 304 includes any means such as a device or circuitry embodied in either hardware or a combination of hardware and software that is configured to receive and/or transmit data from/to a network and/or any other device, circuitry, or module in communication with the quantum measurement processing device 210. In this regard, the communication interface 304 includes, for example in some embodiments, a network interface for enabling communications with a wired or wireless communications network. In some embodiments, the communication interface 304 includes one or more network interface card(s), antenna(s), bus(es), switch(es), router(s), modem(s), and supporting hardware, firmware, and/or software, or any other device suitable for enabling communications via one or more communications network(s). The communication interface 304 includes circuitry for interacting with the antenna(s) and/or other hardware or software to cause transmission of signals via the antenna(s) or to handle receipt of signals received via the antenna(s). In some embodiments, the communication interface 304 enables transmission to and/or receipt of data from a client device in communication with the quantum measurement processing device 210.

The recording circuitry 212 includes hardware, software, firmware, and/or a combination thereof, that supports various functionality associated with determining and recording statistics related to the time of arrival and frequency distribution of the received quantum data (e.g., quantum transmission data 202). In some embodiments, the method and/or apparatus used by the quantum interconnect transmitter 106 may affect the number, frequency, and distribution of the transmitted quantum data. The variations in the statistical distribution of the quantum output may have an impact on a quantum interconnect eavesdropper's 110 ability to determine an encoded value undetected. To avoid detection, a quantum interconnect eavesdropper 110 may determine various statistics of a statistical distribution of the quantum transmission data 202. The recording circuitry 212 may record statistical information related to the arrival times and number of quantum particles and may even record bunching/anti-bunching or quantum particle number/Fock state characteristics of the transmitted quantum particles. This information recorded by the recording circuitry 212 may be saved for future comparison, and/or utilized by the quantum encoding device 218 to generate quantum output data replicating the transmitted quantum particle distribution.

In addition, in some embodiments, the recording circuitry 212 may record the time of arrival and associated state information related to a particular quantum data qubit/qudit. This state information may later be utilized to compare predicted state data with the exchange of data between the quantum interconnect transmitter 106 and the quantum interconnect receiver 108.

In some embodiments, the recording circuitry 212 includes a separate processor, specially configured field programmable gate array (FPGA), or a specially programmed application specific integrated circuit (ASIC).

The digital conversion circuitry 214 includes hardware, software, firmware, and/or a combination thereof, that supports various functionality associated with converting the data sampled by the quantum measurement device 208 to a digital encoding. In some embodiments, the quantum measurement device 208 may transmit measurements based on the physical characteristics of one or more degrees of freedom of a particular quantum particle or set of quantum particles. This data may be representative of a spatial or temporal displacement, a data measurement associated with a specific polarization orientation, and/or the like. The digital conversion circuitry 214 may infer the digital encoding based on the recorded characteristics of the one or more degrees of freedom and output a digital value based on that determination. For example, a ‘0’, ‘1’, ‘01’, ‘11’, etc.

In some embodiments, the conversion circuitry 214 includes a separate processor, specially configured field programmable gate array (FPGA), or a specially programmed application specific integrated circuit (ASIC).

The processing circuitry 216 includes hardware, software, firmware, and/or a combination thereof, that supports various functionality associated with determining the predicted state of the intercepted quantum data based on the measured characteristics of the quantum measurement device 208. In some embodiments, the quantum measurement device 208 may perform a plurality of measurements which are transmitted to the digital conversion circuitry 214 and converted into a data stream. The processing circuitry 216 may receive all input data related to the measured state of the quantum data and predict a state in relation to one or more degrees of freedom. The processing circuitry 216 may transmit the predicted state to the quantum encoding device 218 to generate quantum data associated with the predicted state.

In some embodiments, the processing circuitry 216 includes a separate processor, specially configured field programmable gate array (FPGA), or a specially programmed application specific integrated circuit (ASIC).

In some embodiments, one or more of the sets of circuitry 212, 214, 216, 301, 302, 303, 304 are combinable. In some embodiments, one or more of the sets of circuitry perform some or all of the functionality described associated with another component. For example, in some embodiments, one or more sets of circuitry 212, 214, 216, 301, 302, 303, 304 are combined into a single module embodied in hardware, software, firmware, and/or a combination thereof. Similarly, in some embodiments, one or more of the sets of circuitry, for example recording circuitry 212, digital conversion circuitry 214, and/or processing circuitry 216, is/are combined such that the processor 302 performs one or more of the operations described above with respect to each of these circuitry individually.

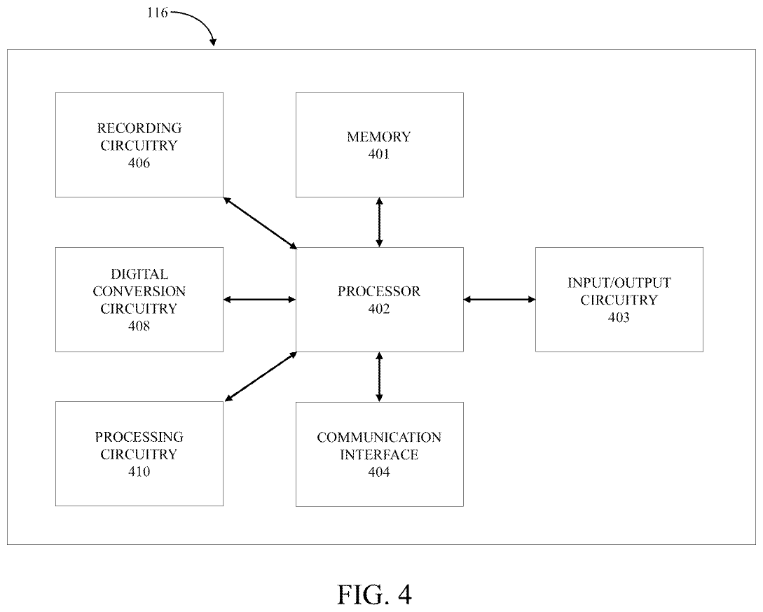

FIG. 4 illustrates a quantum measurement processing device 116 in accordance with at least some example embodiments of the present disclosure. The quantum measurement processing device 116 includes processor 402, input/output circuitry 403, memory 401, communication interface 404, recording circuitry 406, digital conversion circuitry 408, and processing circuitry 410. In some embodiments, the quantum measurement processing device 116 is configured, using one or more of the sets of circuitry 401, 402, 403, 404, 408, and/or 410, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the quantum measurement processing device 116 provide or supplement the functionality of other particular sets of circuitry. For example, the processor 402 in some embodiments provides processing functionality to any of the sets of circuitry, the memory 401 provides storage functionality to any of the sets of circuitry, the communication interface 404 provides network interface functionality to any of the sets of circuitry, and/or the like.

In some embodiments, the processor 402 (and/or co-processor or any other processing circuitry assisting or otherwise associated with the processor) is/are in communication with the memory 401 via a bus for passing information among components of the quantum measurement processing device 116. In some embodiments, for example, the memory 401 is non-transitory and may include, for example, one or more volatile and/or non-volatile memories. In other words, for example, the memory 401 in some embodiments includes or embodies an electronic storage device (e.g., a computer readable storage medium). In some embodiments, the memory 401 is configured to store information, data, content, applications, instructions, or the like, for enabling the quantum measurement processing device 116 to carry out various functions in accordance with example embodiments of the present disclosure.

The processor 402 may be embodied in a number of different ways. For example, in some example embodiments, the processor 402 includes one or more processing devices configured to perform independently. In some embodiments, the processor 402 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the quantum measurement processing device 116, and/or one or more remote or “cloud” processor(s) external to the quantum measurement processing device 116.

In an example embodiment, the processor 402 is configured to execute instructions stored in the memory 401 or otherwise accessible to the processor. Alternatively or additionally, the processor 402 in some embodiments is configured to execute hard-coded functionality. As such, whether configured by hardware or software methods, or by a combination thereof, the processor 402 represents an entity (e.g., physically embodied in circuitry) capable of performing operations according to an embodiment of the present disclosure while configured accordingly. Alternatively or additionally, as another example in some example embodiments, when the processor 402 is embodied as an executor of software instructions, the instructions specifically configure the processor 402 to perform the algorithms embodied in the specific operations described herein when such instructions are executed.

As one particular example embodiment, the processor 402 is configured to perform various operations associated with eavesdropping a value transmitted on a quantum interconnect link 102. In some embodiments, the processor 402 includes hardware, software, firmware, and/or a combination thereof, that receives a quantum particle of a plurality of quantum particles transmitted on the quantum interconnect link 102. In some embodiments, the processor 402 includes hardware, software, firmware, and/or a combination thereof, that determines one or more characteristics of one or more degrees of freedom of the quantum particle. In some embodiments, the processor 402 includes hardware, software, firmware, and/or a combination thereof, that infers the value based at least in part on the one or more characteristics of the one or more degrees of freedom of the quantum particle. In some embodiments, the processor 402 includes hardware, software, firmware, and/or a combination thereof, that predicts a state of the one or more degrees of freedom of the quantum particle. In some embodiments, the processor 402 includes hardware, software, firmware, and/or a combination thereof, that encodes an output quantum particle with characteristics based at least in part on the predicted state. In some embodiments, the processor 402 includes hardware, software, firmware, and/or a combination thereof, that transmits the output quantum particle on the quantum interconnect link 102.

In some embodiments, the quantum measurement processing device 116 includes input/output circuitry 403 that provides output to the user and, in some embodiments, to receive an indication of a user input. In some embodiments, the input/output circuitry 403 is in communication with the processor 402 to provide such functionality. The input/output circuitry 403 may comprise one or more user interface(s) (e.g., user interface) and in some embodiments includes a display that comprises the interface(s) rendered as a web user interface, an application user interface, a user device, a backend system, or the like. The processor 402 and/or input/output circuitry 403 comprising the processor may be configured to control one or more functions of one or more user interface elements through computer program instructions (e.g., software and/or firmware) stored on a memory accessible to the processor (e.g., memory 401, and/or the like). In some embodiments, the input/output circuitry 403 includes or utilizes a user-facing application to provide input/output functionality to a client device and/or other display associated with a user.

In some embodiments, the quantum measurement processing device 116 includes communication interface 404. The communication interface 404 includes any means such as a device or circuitry embodied in either hardware or a combination of hardware and software that is configured to receive and/or transmit data from/to a network and/or any other device, circuitry, or module in communication with the quantum measurement processing device 116. In this regard, the communication interface 404 includes, for example in some embodiments, a network interface for enabling communications with a wired or wireless communications network. In some embodiments, the communication interface 404 includes one or more network interface card(s), antenna(s), bus(es), switch(es), router(s), modem(s), and supporting hardware, firmware, and/or software, or any other device suitable for enabling communications via one or more communications network(s). In some embodiments, the communication interface 404 includes circuitry for interacting with the antenna(s) and/or other hardware or software to cause transmission of signals via the antenna(s) or to handle receipt of signals received via the antenna(s). In some embodiments, the communication interface 404 enables transmission to and/or receipt of data from a client device in communication with the quantum measurement processing device 116.

The recording circuitry 406 includes hardware, software, firmware, and/or a combination thereof, that supports various functionality associated with determining and recording statistics related to the time of arrival, frequency distribution, physical characteristics, and/or bases used of the received quantum data (e.g., quantum transmission data 202). The recorded bases may later be utilized to compare transmitted values with received values between the quantum interconnect transmitter 106 and the quantum interconnect receiver 108 in order to detect the presence of an eavesdropper.

In some embodiments, the recording circuitry 406 includes a separate processor, specially configured field programmable gate array (FPGA), or a specially programmed application specific integrated circuit (ASIC).

The digital conversion circuitry 408 includes hardware, software, firmware, and/or a combination thereof, that supports various functionality associated with converting the information provided by the quantum measurement device 208 associated with the physical characteristics of the quantum data to a digital encoding. In some embodiments, the quantum measurement device 208 may transmit measurements based on the physical characteristics of one or more degrees of freedom of a particular quantum particle or set of quantum particles. This data may be representative of a spatial or temporal displacement, a data measurement associated with a specific polarization orientation, and/or the like. The digital conversion circuitry 408 may infer the digital encoding based on the recorded characteristics of the one or more degrees of freedom and output a digital value based on that determination. For example, a ‘0’, ‘1’, ‘01’, ‘11’, etc. In some embodiments, this conversion may comprise applying the measurements to a selected basis of a particular degree of freedom and determining the encoded value based on the measurements.

In some embodiments, the digital conversion circuitry 408 includes a separate processor, specially configured field programmable gate array (FPGA), or a specially programmed application specific integrated circuit (ASIC).

The processing circuitry 410 includes hardware, software, firmware, and/or a combination thereof, that supports various functionality associated with determining the encoded value associated with a quantum particle and detecting anomalies and potential eavesdroppers on the quantum interconnect link 102, based on the measured characteristics from the quantum measurement device 208. In some embodiments, the quantum measurement device 208 may perform a plurality of measurements which are transmitted to the digital conversion circuitry 408 and converted into digital qubits/qudits.

When transmitting quantum output data 222, the processing circuitry 410 may further determine the physical characteristics of the transmitted quantum particles and configure the quantum encoding device 218 to output quantum particles according to the determine state

In some embodiments, the processing circuitry 410 includes a separate processor, specially configured field programmable gate array (FPGA), or a specially programmed application specific integrated circuit (ASIC).

In some embodiments, one or more of the sets of circuitry 406, 408, 410, 401, 402, 403, 404 are combinable. In some embodiments, one or more of the sets of circuitry perform some or all of the functionality described associated with another component. For example, in some embodiments, one or more sets of circuitry 406, 408, 410, 401, 402, 403, 404 are combined into a single module embodied in hardware, software, firmware, and/or a combination thereof. Similarly, in some embodiments, one or more of the sets of circuitry, for example recording circuitry 406, digital conversion circuitry 408, and/or processing circuitry 410, is/are combined such that the processor 402 performs one or more of the operations described above with respect to each of these circuitry individually.

### Methods for Intercepting and Resending Quantum Particles in a Quantum Communication System

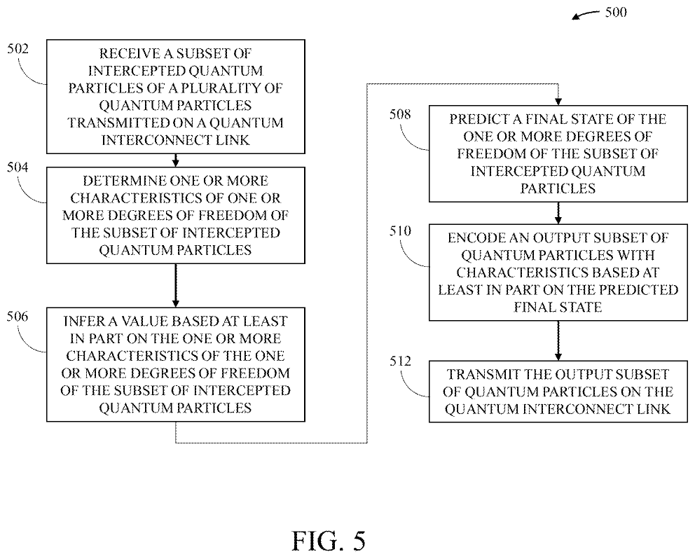

FIG. 5 illustrates a flowchart of an example process 500 for intercepting and resending a transmission of quantum data by an eavesdropper to avoid detection. The operations illustrated in FIG. 5 may, for example, be performed by, with the assistance of, and/or under the control of a quantum interconnect eavesdropper 110, as described above. In this regard, performance of the operation may invoke one or more of processor 302, input/output circuitry 303, memory 301, communication interface 304, recording circuitry 212, digital conversion circuitry 214, and/or processing circuitry 216.

As shown in block 502, the method may include receiving a subset of intercepted quantum particles of a plurality of quantum particles transmitted on a quantum interconnect link 102. As described in relation to FIG. 1, a quantum interconnect transmitter 106 and a quantum interconnect receiver 108 may transmit data by encoding a value in the physical characteristics of a quantum particle (e.g., photon, electron, atom, etc.). In some embodiments, a plurality of quantum particles may be transmitted on the quantum interconnect link 102 in the process of transmitting encoded data. A quantum interconnect eavesdropper 110 may receive a quantum particle of the plurality of quantum particles by physically connecting to the quantum interconnect link 102 and/or by otherwise capturing the transmitted quantum data.

As shown in block 504, the method may further include determining one or more characteristics of one or more degrees of freedom of the subset of intercepted quantum particles. A quantum interconnect link 102 or similar device may perform one or more measurements on the received plurality of quantum particles. As described in relation to FIG. 1 and FIG. 2, a degree of freedom may be any physical characteristic of the quantum particle that a quantum interconnect transmitter (e.g., quantum interconnect transmitter 106) may manipulate to encode a measurable state (e.g., polarization, time-of-arrival, spatial displacement, relative phase, temporal displacement, orbital angular momentum, spatial modes, energy/frequency, quantized quadratures, spin of the electron, etc.). In addition, the characteristics may represent any state the quantum particles can occupy within the degree of freedom. As further described in FIG. 2, in order to avoid detection, a quantum interconnect eavesdropper 110 may need to utilize weak measurements to determine the characteristics.

As shown in block 506, the method may further include inferring a value based at least in part on the one or more characteristics of the one or more degrees of freedom of the subset of intercepted quantum particles. As described in relation to FIG. 2, weak measurements may utilize the characteristics, of the quantum particles in a second degree of freedom (auxiliary degree of freedom) to infer a value that may be encoded in a first degree of freedom (primary degree of freedom). A number of devices for performing weak measurements are discussed in relation to FIG. 2. A quantum interconnect eavesdropper 110 may utilize the measurements related to the characteristics in an auxiliary degree of freedom to infer a value encoded in the primary degree of freedom. In some embodiments, a quantum interconnect eavesdropper 110 may utilize multiple quantum measurement devices 208, each configured to measure one or more (a subset) of degrees of freedom, to measure characteristics in a plurality of degrees of freedom. For example, a first quantum measurement device 208 may be configured to detect a quantum particle polarization, while a second quantum measurement device 208 is configured to detect a quantum particle spin. In such an embodiment, the quantum interconnect eavesdropper 110 may consider all of the measured characteristics to infer one or more encoded values.

As shown in block 508, the method may further include predicting a state of one or more degrees of freedom of the subset of intercepted quantum particles. In addition to inferring an encoded value based on the measured characteristics of the one or more degrees of freedom, a quantum interconnect eavesdropper 110 may also predict the state of the quantum particles as it is predicted to be received by the quantum interconnect receiver 108, particularly in the measured degree of freedom. In some embodiments, a weak measurement may affect the state of the quantum particle, especially the state of the degree of freedom in which the measurement was performed. For example, a quantum interconnect eavesdropper 110 may measure the spatial displacement of a quantum particle using a Stern-Gerlach or similar device to infer the spin of the electrons. By measuring the spatial displacement, the quantum interconnect eavesdropper 110 has modified the state of the quantum particles. As such, the quantum interconnect eavesdropper 110 may utilize the measured characteristics to predict the state of the measured degrees of freedom, had no measurement been made.

As shown in block 510, the method may further include encoding an output subset of quantum particles with characteristics based at least in part on the predicted state. As described in relation to FIG. 2, a quantum interconnect eavesdropper 110 may utilize a quantum encoding device 218 or similar device to encode output quantum particles based on the predicted state of the transmitted quantum particles. In some embodiments, a quantum interconnect eavesdropper 110 may measure characteristics and predict the state in one or more degrees of freedom. A quantum interconnect eavesdropper 110 may be configured to generate quantum particles such that the physical characteristics match the predicted state of the quantum particle based on the measured characteristics.

As shown in block 512, the method may further include transmitting the output subset of quantum particles on the quantum interconnect link 102. As described in relation to FIG. 2, in some embodiments, the quantum interconnect eavesdropper 110 may utilize a beam combiner 220 to combine the encoded quantum particles with the quantum bypass data 204. The encoded quantum particles may be synchronized with the quantum bypass data 204 to replicate the quantum transmission data 202 initially intercepted on the quantum interconnect link 102, thereby minimizing the likelihood of detection of the eavesdropper, at least in part because the output quantum particles are manipulated so as to resemble a quantum particle that bypassed the eavesdropper.

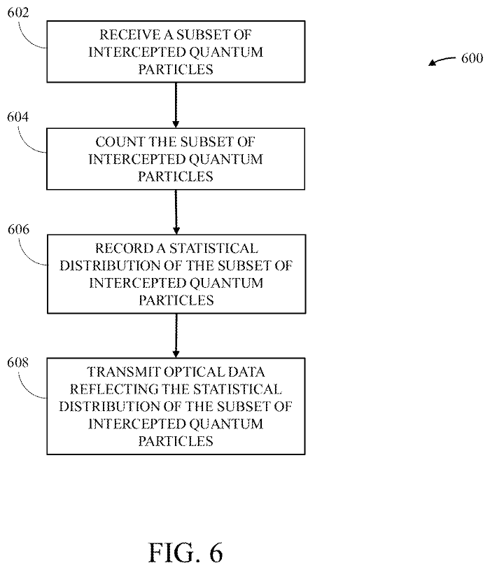

FIG. 6 illustrates a flowchart of an example process 600 for determining a statistical distribution of a plurality of quantum particles and transmitting a generated plurality of quantum particles based at least in part on that determined distribution. In some embodiments, a quantum interconnect receiver 108 and a quantum interconnect transmitter 106 may vary the count and frequency of transmitted quantum particles to further detect the presence of an eavesdropper. To avoid detection, a quantum interconnect eavesdropper 110 may record statistics related to the statistical distribution of the quantum transmission data 202 and replicate the recorded statistical distribution in the quantum output data 222. In some embodiments, the operations illustrated in FIG. 6 may, for example, be performed by, with the assistance of, and/or under the control of a quantum interconnect eavesdropper 110, as described above. In this regard, performance of the operation may invoke one or more of processor 302, input/output circuitry 303, memory 301, communication interface 304, recording circuitry 212, digital conversion circuitry 214, and/or processing circuitry 216.

As shown in block 602, the method may include receiving a subset of intercepted quantum particles. As discussed in relation to block 502 of FIG. 5, a quantum interconnect eavesdropper 110 may receive a subset of quantum particles of the plurality of quantum particles by physically connecting to the quantum interconnect link 102 and/or by otherwise capturing the transmitted quantum data.

As shown in block 604, the method may further include counting the subset of intercepted quantum particles. A quantum interconnect eavesdropper 110 may include a device and/or circuitry capable of counting transmitted quantum particles. In some embodiments, the quantum measurement device 208 may be configured to count intercepted quantum particles and transmit the representative data to the quantum measurement processing device 210. In some embodiments, the quantum interconnect eavesdropper 110 may count all quantum particles, including those that bypass the optical measuring device or devices. In some embodiments, the quantum interconnect eavesdropper 110 may count only those quantum particles passing through the optical measuring device or devices. In some embodiments, the quantum interconnect eavesdropper 110 may associate and record a time with the recorded quantum particles. In some embodiments, the quantum interconnect eavesdropper 110 may associate and record a number of quantum particles with a particular period of time.

As shown in block 606, the method may further include recording a statistical distribution of the subset of intercepted quantum particles. Once the quantum particles are counted, the quantum interconnect eavesdropper 110 may utilize recording circuitry (e.g., recording circuitry 212) to store the count captured by the quantum measurement device 208. In some embodiments, the recorded count may associate the counted quantum particle or quantum particles with a time (e.g., an arrival time). In some embodiments, the recording circuitry 212 may determine a statistical distribution based on the captured count of quantum particles and associated timestamps. In some embodiments, the recording circuitry 212 may record data representative of bunching/anti-bunching statistics, quantum particle number/Fock state statistics, and other similar data related to the frequency and composition of transmitted quantum particles.

As shown in block 608, the method may further include transmitting optical data reflecting the statistical distribution of the subset of intercepted quantum particles. As discussed in relation to FIG. 2, a quantum interconnect eavesdropper 110 may include a quantum encoding device (e.g., quantum encoding device 218) that is configured to output quantum particles according to a recorded distribution. The quantum encoding device 218 may receive information related to the frequency and composition of the received quantum transmission data 202. The quantum encoding device 218 may then generate quantum particles closely replicating the frequency and composition of the quantum transmission data 202 according to the recorded statistical distribution and other state information. Transmitting quantum output data 222 replicating the statistical distribution and other state information of the received quantum transmission data 202 may further allow a quantum interconnect eavesdropper 110 to avoid detection.

### Method for Adjusting Weak Measurement in a Quantum Communication System

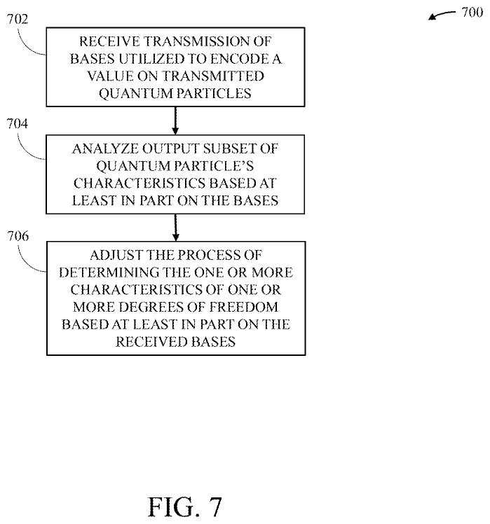

FIG. 7 illustrates a flowchart of an example process 700 for adjusting the techniques utilized to measure intercepted quantum particles based on basis data shared between the quantum interconnect receiver 108 and the quantum interconnect transmitter 106. The operations illustrated in FIG. 7 may, for example, be performed by, with the assistance of, and/or under the control of a quantum interconnect eavesdropper 110, as described above. Performance of the operation may invoke one or more of processor 302, input/output circuitry 303, memory 301, communication interface 304, recording circuitry 212, digital conversion circuitry 214, and/or processing circuitry 216.

As shown in block 702, the method may include receiving transmission of bases utilized to encode a value on transmitted quantum particles. In a quantum communication network 100, the quantum interconnect transmitter 106 and the quantum interconnect receiver 108 may periodically exchange the bases used during encoding and subsequent decoding of quantum data, to determine the valid transmitted data and to detect anomalies and/or an eavesdropper on the quantum interconnect link 102. In some embodiments, the quantum interconnect eavesdropper 110 may intercept the exchange of bases by, for example, monitoring data exchanges on the communication network 104, accessing a shared location of stored basis, hacking a transmitting or receiving device, or by similar means. The received data related to the bases may include transmitted/received bases, as well as associated timestamps, etc.

As shown in block 704, the method may further include analyzing output subset of quantum particle's characteristics based at least in part on the bases. A quantum interconnect eavesdropper 110 may analyze the received bases to determine if the disturbance created by the measuring devices of the quantum interconnect eavesdropper 110 is comparable to the noise level existing on the quantum interconnect link 102. A quantum interconnect eavesdropper 110 may determine this by ensuring the total quantum-bit-error rate is lower than the threshold defined by the quantum interconnect transmitter 106 and the quantum interconnect receiver 108 for aborting the protocol. For example, if the predefined threshold quantum-bit-error rate is set at 8%, a quantum interconnect eavesdropper 110 may analyze the received bases to determine if the current quantum-bit-error rate between the quantum interconnect transmitter 106 and the quantum interconnect receiver 108 is at or below 8%. In an instance in which the quantum-bit-error rate exceeds the threshold quantum-bit-error rate, the quantum interconnect eavesdropper 110 may determine that the disturbance caused by the measurements performed is too great.

As shown in block 706, the method may further include adjusting the process of determining the one or more characteristics of one or more degrees of freedom based at least in part on the received bases. In an instance in which the quantum interconnect eavesdropper 110 determines the quantum-bit-error rate exceeds the threshold quantum-bit-error rate established between the quantum interconnect transmitter 106 and the quantum interconnect receiver 108, a quantum interconnect eavesdropper 110 may take steps to adjust the process related to the determination of the encoded value and prediction of state. For example, a quantum interconnect eavesdropper 110 may adjust the measurement devices of the quantum measurement device 208 to reduce the disturbance to the intercepted quantum transmission data 202. As another example, a quantum interconnect eavesdropper 110 may increase or decrease the amount of optical data bypassing the measurement circuitry. Further, the quantum interconnect eavesdropper 110 may for example, adjust parameters used to determine and predict the state of the measured quantum particles.

In addition, in some embodiments, the quantum interconnect eavesdropper 110 may establish a threshold quantum-bit-error rate based on the quantum-bit-error rate predefined by the quantum interconnect transmitter 106 and the quantum interconnect receiver 108. For example, the quantum interconnect eavesdropper 110 may select a threshold lower than the predefined quantum-bit-error rate threshold to further avoid detection. Further, in an instance in which the quantum interconnect eavesdropper 110 determines the quantum-bit-error rate is sufficiently low, the quantum interconnect eavesdropper 110 may adjust the optical measuring devices performing weak measurements to gather more information related to the state of the quantum particles, in an effort to increase the accuracy of the inferred encoded value and the predicted state of the quantum particles.

Many modifications and other embodiments will come to mind to one skilled in the art to which this disclosure pertains having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for eavesdropping a value transmitted on a quantum interconnect link, the method comprising:
receiving a subset of intercepted quantum particles of a plurality of quantum particles transmitted on the quantum interconnect link;
determining one or more characteristics of one or more degrees of freedom of the subset of intercepted quantum particles;
inferring the value based at least in part on the one or more characteristics of the one or more degrees of freedom of the subset of intercepted quantum particles;
predicting a state of the one or more degrees of freedom of the subset of intercepted quantum particles;
encoding an output subset of quantum particles with characteristics based at least in part on the predicted state; and
transmitting the output subset of quantum particles on the quantum interconnect link.

2. The method of claim 1, wherein determining one or more characteristics of one or more degrees of freedom of the subset of intercepted quantum particles comprises performing a weak measurement in a first degree of freedom and utilizing the result of the weak measurement to determine a characteristic of a second degree of freedom, and wherein the first degree of freedom correlates with the second degree of freedom.

3. The method of claim 1, further comprising recording a timestamp associated with state information of the subset of intercepted quantum particles.

4. The method of claim 1, further comprising:
counting the subset of intercepted quantum particles;
recording a statistical distribution of the subset of intercepted quantum particles, and
transmitting optical data reflecting the statistical distribution of the subset of intercepted quantum particles.

5. The method of claim 1, wherein the plurality of quantum particles are transmitted on the quantum interconnect link between a transmitter and a receiver, and wherein:
receiving the subset of intercepted quantum particles of the plurality of quantum particles comprises receiving, via an interceptor the subset of intercepted quantum particles such that a remaining portion of the plurality of quantum particles bypass the interceptor; and
transmitting the output subset of quantum particles on the quantum interconnect link comprises combining the output subset of quantum particles with the remaining portion of the plurality of quantum particles.

6. The method of claim 1, wherein the one or more degrees of freedom comprise one or more of: polarization, time-of-arrival, spatial displacement, relative phase, orbital angular momentum, spatial modes, energy/frequency, quantized quadratures, and/or spin.

7. The method of claim 1, wherein the inferred value represents one or more qudits.

8. The method of claim 1, wherein determining one or more characteristics of one or more degrees of freedom of the subset of intercepted quantum particles comprises:
identifying one or more measured degrees of freedom; and
determining the characteristic of the one or more measured degrees of freedom.

9. An apparatus for eavesdropping a value transmitted on a quantum interconnect link, the apparatus comprising:
a quantum measurement device coupled with the quantum interconnect link, wherein the quantum measurement device is configured to:
receive a subset of intercepted quantum particles of a plurality of quantum particles,
wherein the quantum measurement device is configured to determine one or more characteristics of one or more degrees of freedom of the subset of intercepted quantum particles;
digital conversion circuitry electrically connected to the quantum measurement device, wherein the digital conversion circuity is configured to:
infer the value based at least in part on the one or more characteristics of the one or more degrees of freedom of the subset of intercepted quantum particles;
processing circuitry electrically connected to the digital conversion circuitry,
wherein the processing circuitry is configured to predict a state of the one or more degrees of freedom of the subset of intercepted quantum particles; and
a quantum encoding device configured to generate output optical data,
wherein the output optical data comprises an output subset of quantum particles encoded with characteristics based at least in part on the predicted state.

10. The apparatus of claim 9, wherein determining one or more characteristics of one or more degrees of freedom of the subset of intercepted quantum particles comprises performing a weak measurement in a first degree of freedom and utilizing the result of the weak measurement to determine a characteristic of a second degree of freedom, and wherein the first degree of freedom correlates with the second degree of freedom.

11. The apparatus of claim 9, further comprising recording circuitry, wherein the recording circuitry is configured to record the one or more characteristics associated with the one or more degrees of freedom of the subset of intercepted quantum particles.

12. The apparatus of claim 11, wherein the recording circuitry is further configured to count the subset of intercepted quantum particles and record a statistical distribution of the subset of intercepted quantum particles, such that the quantum encoding device generates the output optical data to reflect the statistical distribution of the subset of intercepted quantum particles.

13. The apparatus of claim 9, further comprising an interceptor and a beam combiner,
wherein the interceptor is configured to transmit the subset of intercepted quantum particles to the quantum measurement device such that a remaining portion of the plurality of quantum particles bypass the interceptor; and
wherein the beam combiner is configured to combine the output optical data with the remaining portion of the plurality of quantum particles.

14. The apparatus of claim 9, wherein the one or more degrees of freedom of the subset of intercepted quantum particles comprise one or more of: polarization, time-of-arrival, spatial displacement, relative phase, orbital angular momentum, spatial modes, energy/frequency, quantized quadratures, and/or spin.

15. The apparatus of claim 9, wherein the inferred value represents one or more qudits.

16. The apparatus of claim 9, wherein determining one or more characteristics of one or more degrees of freedom of the subset of intercepted quantum particles comprises:
identifying one or more measured degrees of freedom; and
determining the characteristic of the one or more measured degrees of freedom.

17. A computer program product for eavesdropping a value transmitted on a quantum interconnect link, the computer program product comprising at least one non-transitory computer-readable storage medium storing program instructions that, when executed, cause the computer program product to:
receive a subset of intercepted quantum particles of a plurality of quantum particles transmitted on the quantum interconnect link;
determine one or more characteristics of one or more degrees of freedom of the subset of intercepted quantum particles;
infer the value based at least in part on the one or more characteristics of the one or more degrees of freedom of the subset of intercepted quantum particles;
predict a state of the one or more degrees of freedom of the subset of intercepted quantum particles;
encode an output subset of quantum particles with characteristics based at least in part on the predicted state; and
transmit the output subset of quantum particles on the quantum interconnect link.

18. The computer program product of claim 17, wherein the computer program is further configured to:
count the subset of intercepted quantum particles;
record a statistical distribution of the subset of intercepted quantum particles, and
cause a quantum encoding device to transmit an output stream of optical data reflecting the statistical distribution of the subset of intercepted quantum particles.

19. The computer program product of claim 17, wherein the plurality of quantum particles are transmitted on the quantum interconnect link between a transmitter and a receiver, and wherein:
receiving a subset of intercepted quantum particles of the plurality of quantum particles comprises receiving, via an interceptor the subset of intercepted quantum particles such that a remaining portion of the plurality of quantum particles bypass the interceptor; and
transmitting the output subset of quantum particles on the quantum interconnect link comprises combining the output subset of quantum particles with the remaining portion of the plurality of quantum particles.

20. The computer program product of claim 17, wherein the one or more degrees of freedom comprise one or more of: polarization, time-of-arrival, spatial displacement, relative phase, orbital angular momentum, spatial modes, energy/frequency, quantized quadratures, and/or spin.
